(19) United States
(12) Patent Application Publication
(10) Pub. No.: US 2025/0279737 A1
(43) Pub. Date: Sep. 4, 2025

(54) Motor Driving Method

(71) Applicant: SHINANO KENSHI KABUSHIKI KAISHA, Nagano (JP)

(72) Inventors: Takaaki MATSUDA, Nagano (JP); Eiji HIRACHI, Nagano (JP); Shigeru MIZUI, Nagano (JP)

(21) Appl. No.: 19/052,599

(22) Filed: Feb. 13, 2025

(30) Foreign Application Priority Data
Mar. 4, 2024 (JP) 2024-032102

(51) Int. Cl. H02P 6/18

(52) U.S. Cl. CPC H02P 6/18

(57) ABSTRACT

The control circuit is configured to, upon reception of an input of a given minimum value as a modulation signal, output a pulse signal at a duty ratio of 0% to an inverter circuit, upon reception of an input of a given maximum value as the modulation signal, output a pulse signal at a duty ratio of 100% to the inverter circuit, and in an overmodulation state, output a pulse signal at a duty ratio of 100% to the inverter circuit. The overmodulation state is a state in which an overmodulation signal having a maximum modulation degree of more than 100% is input as the modulation signal and an instantaneous value of the modulation signal is more than the given maximum value. The maximum modulation degree is a ratio of a maximum value of the modulation signal to the given maximum value.

### CROSS-REFERENCE TO RELATED APPLICATION

This application is based upon and claims the benefit of priority of the prior Japanese Patent Application No. 2024-032102, filed on Mar. 4, 2024, and the entire contents of which are incorporated herein by reference.

### TECHNICAL FIELD

The present disclosure relates to a motor driving method for sinusoidally driving, by a pulse width modulation method, a three-phase direct-current brushless motor for HVAC (Heating, Ventilation and Air Conditioning) or the like in a sensorless manner.

### BACKGROUND ART

When a three-phase direct-current brushless motor that does not utilize a hall sensor for positional detection of a permanent magnet field system is sinusoidally driven by pulse width modulation control (PWM control), overmodulation control is not performed in order not to impede positional detection of the permanent magnet field system. Although a method of superimposing a harmonic on a fundamental sine wave is used, this is performed in such a manner as not to cause overmodulation.

The use of sinusoidal drive can reduce noise and vibration of the three-phase direct-current brushless motor. However, there is a problem that although two-phase modulation causes a large maximum output, it causes large noise and vibration as compared to three-phase modulation, and although three-phase modulation causes small noise and small vibration as compared to two-phase modulation, it causes a small maximum output.

In order to solve the problem, a motor driving method has been proposed, which is capable of achieving both of a large output by two-phase modulation and small noise and small vibration by three-phase modulation in such a way that switching of two-phase modulation for outputting alternating current in a sinusoidal shape is made to be three-phase modulation through addition of a same modulation period to all the phases including a non-modulation phase within a carrier period, and the added modulation period is caused to be half an unenergized period within the carrier period before the addition (PTL 1: JP4581391B).

### SUMMARY OF INVENTION

### Technical Problem

In the case of sinusoidal drive of a three-phase direct-current brushless motor by PWM control in a sensorless manner, dead time is used for positional detection of a permanent magnet field system, and thereby an output at a duty ratio of 100% is less likely to be used actively. Accordingly, problems, for example, a motor maximum output cannot be high, a maximum rotation speed or a maximum output decreases as back electromotive force of a motor increases, and a switching frequency of a switching device such as a FET provided to an inverter circuit in a motor driving apparatus increases, thus increasing a heat generation amount of the switching device, are caused.

### Solution to Problem

The present disclosure is made in order to solve the variety of problems described above, and an object thereof is to provide a motor driving method for driving a three-phase direct-current brushless motor by overmodulation PWM control at a modulation degree within a given range more than 100% in a sensorless manner to allow improvement in a motor maximum output to be expected while securing dead time.

In a motor driving method for driving a three-phase brushless motor in a pulse width modulation method, the three-phase brushless motor includes an inverter circuit and a control circuit. The inverter circuit includes an output element provided with a pair of a high-side arm and a low-side arm for each of three phases of the three-phase brushless motor, and outputs current to a coil of each of the three phases. The control circuit controls an output of a pulse signal to the inverter circuit by performing pulse width modulation to determine a duty ratio based on an input modulation signal and output a pulse signal. The control circuit is configured to, upon reception of an input of a given minimum value as the modulation signal, output a pulse signal at a duty ratio of 0% to the inverter circuit. The control circuit is configured to, upon reception of an input of a given maximum value as the modulation signal, output a pulse signal at a duty ratio of 100% to the inverter circuit. The control circuit is configured to, in an overmodulation state, output a pulse signal at a duty ratio of 100% to the inverter circuit. The overmodulation state is a state in which an overmodulation signal having a maximum modulation degree of more than 100% is input as the modulation signal and an instantaneous value of the modulation signal is more than the given maximum value. The maximum modulation degree is a ratio of a maximum value of the modulation signal to the given maximum value.

In this manner, in the case in which the overmodulation signal having the maximum modulation, which is the ratio of the maximum value of the modulation signal to the given maximum value degree, of more than 100% is input as the modulation signal, when the instantaneous value of the modulation signal is more than the given maximum value, the control circuit outputs the pulse signal at the duty ratio of 100% to the inverter circuit. Therefore, in addition to a reduction in noise and vibration, a motor output can improve, and the number of switching can be reduced to suppress heat generation of a switching device.

The modulation signal may be a signal obtained through superimposition of, on a sine wave at a given frequency, a sine wave at a frequency three times the given frequency, and a modulation degree in the overmodulation state using the superimposed signal as the modulation signal may be 130% at the maximum.

In this manner, when the modulation signal obtained through superimposition of, on the sine wave at the given frequency, the sine wave at the frequency three times the given frequency is used, the modulation degree in the overmodulation is 130% at the maximum. Therefore, the motor maximum output can improve while having the upper limit of the modulation degree at 130% at which the motor output level hits a peak.

The three-phase brushless motor may be a sensorless motor.

In this case, positional detection precision of a permanent magnet field system in sensorless drive can be secured while dead time for positional detection of the permanent magnet field system is secured.

A method for positional detection of a rotor of the sensorless motor may be one or both of a single-shunt FOC sensorless detection method in which at least one phase in sensing for magnetic pole positional estimation is in a switching state, and a detection method in which sensing for magnetic pole positional estimation is performed during dead time.

In this manner, by the sensorless motor being driven in the overmodulation state at a modulation degree within a given range more than 100%, regardless of whether the motor is rotating or in a stopped state, improvement in the motor maximum output can be expected while securing dead time in sensing for magnetic pole positional estimation.

The control circuit may include a three-phase modulation operation mode, a two-phase modulation operation mode, and a transitional operation mode. In the three-phase modulation operation mode, the motor is driven by outputting a pulse width modulation signal to the coil of each of the three phases of the three-phase brushless motor. In the two-phase modulation operation mode, the motor is driven by outputting a pulse width modulation signal to the coil of each of two phases among the three phases of the three- phase brushless motor. In the transitional operation mode, the motor is driven by outputting a transition modulation signal in which a mixture ratio of a pulse width modulation signal for each phase in the three-phase modulation operation mode and a pulse width modulation signal for each phase in the two-phase modulation operation mode is gradually changed. The three-phase operation mode may be operated from a startup until an output reaches a maximum output in the overmodulation state, the two-phase operation mode may be operated from a startup until an output reaches a maximum output in the overmodulation state, or the three-phase operation mode may be operated at a startup, and then as an output increases, the three-phase operation mode may be switched to the two-phase operation mode until the output reaches a maximum output in the overmodulation state via the transitional operation mode.

Accordingly, during low-speed drive, the three-phase direct-current brushless motor is driven by a three-phase overmodulation PWM driving signal that excels in controllability, and in the case of high-speed rotation, high load, or high temperature, the three-phase direct-current brushless motor is driven by a two-phase overmodulation PWM driving signal that excels in energy utilization efficiency, and thereby a high output during low-speed drive reduces vibration and noise, and a high output during high-speed rotation, high load, or high temperature can reduce the number of switching to decrease a heat generation amount of the switching device, thus contributing to energy conservation.

### Advantageous Effects of Invention

A motor driving method for driving a three-phase direct-current brushless motor by overmodulation PWM control at a modulation degree within a given range more than 100% in a sensorless manner to allow improvement in a motor maximum output to be expected while securing dead time can be provided.

### BRIEF DESCRIPTION OF DRAWINGS

FIG. 1 is a terminal voltage waveform chart when a modulation signal applied to a motor coil in a three-phase modulation operation mode is a sine wave.

FIG. 2 is an interphase voltage waveform chart in the three-phase modulation operation mode in FIG. 1.

FIG. 3 is a terminal voltage waveform chart when a modulation signal applied to each motor coil in the three-phase modulation operation mode is a sine wave obtained through ⅙ superimposition of a third harmonic on a fundamental wave.

FIG. 4 is an interphase voltage waveform chart in the three-phase modulation operation mode in FIG. 3.

FIG. 5 is a terminal voltage waveform chart when a modulation signal applied to each motor coil in the three-phase modulation operation mode is a sine wave and a modulation degree is 100%.

FIG. 6 is a terminal voltage waveform chart when a modulation signal applied to each motor coil in the three-phase modulation operation mode is a sine wave and a modulation degree is 130%.

FIG. 7 is a terminal voltage waveform chart when a modulation signal applied to each motor coil in the three-phase modulation operation mode is a sine wave obtained through ⅙ superimposition of a third harmonic on a fundamental wave, and a modulation degree is 80%.

FIG. 8 is an interphase voltage waveform chart in the three-phase modulation operation mode in FIG. 7.

FIG. 9 is a terminal voltage waveform chart when a modulation signal applied to each motor coil in the three-phase modulation operation mode is a sine wave obtained through ⅙ superimposition of a third harmonic on a fundamental wave, and a modulation degree is 100%.

FIG. 10 is an interphase voltage waveform chart in the three-phase modulation operation mode in FIG. 9.

FIG. 11 is a terminal voltage waveform chart when a modulation signal applied to each motor coil in the three-phase modulation operation mode is a sine wave obtained through ⅙ superimposition of a third harmonic on a fundamental wave, and a modulation degree is 115%.

FIG. 12 is an interphase voltage waveform chart in the three-phase modulation operation mode in FIG. 11.

FIG. 13 is a terminal voltage waveform chart when a modulation signal applied to each motor coil in the three-phase modulation operation mode is a sine wave obtained through ⅙ superimposition of a third harmonic on a fundamental wave, and a modulation degree is 130%.

FIG. 14 is an interphase voltage waveform chart in the three-phase modulation operation mode in FIG. 13.

FIG. 15 is a terminal voltage waveform chart when a modulation signal applied to each motor coil in the three-phase modulation operation mode is a sine wave obtained through ⅙ superimposition of a third harmonic on a fundamental wave, and a modulation degree is 180%.

FIG. 16 is an interphase voltage waveform chart in the three-phase modulation operation mode in FIG. 15.

FIG. 17 is a terminal voltage waveform chart when a modulation signal applied to each motor coil in a two-phase modulation operation mode, which is a composite waveform of a switching phase, is a sine wave obtained through ⅙ superimposition of a third harmonic on a fundamental wave, and a modulation degree is 80%.

FIG. 18 is an interphase voltage waveform chart in the two-phase modulation operation mode in FIG. 17.

FIG. 19 is a terminal voltage waveform chart when a modulation signal applied to each motor coil in the two-phase modulation operation mode, which is a composite waveform of a switching phase, is a sine wave obtained through ⅙ superimposition of a third harmonic on a fundamental wave, and a modulation degree is 100%.

FIG. 20 is an interphase voltage waveform chart in the two-phase modulation operation mode in FIG. 19.

FIG. 21 is a terminal voltage waveform chart when a modulation signal applied to each motor coil in the two-phase modulation operation mode, which is a composite waveform of a switching phase, is a sine wave obtained through ⅙ superimposition of a third harmonic on a fundamental wave, and a modulation degree is 115%.

FIG. 22 is an interphase voltage waveform chart in the two-phase modulation operation mode in FIG. 21.

FIG. 23 is a terminal voltage waveform chart when a modulation signal applied to each motor coil in the two-phase modulation operation mode, which is a composite waveform of a switching phase, is a sine wave obtained through ⅙ superimposition of a third harmonic on a fundamental wave, and a modulation degree is 130%.

FIG. 24 is an interphase voltage waveform chart in the two-phase modulation operation mode in FIG. 23.

FIG. 25 is a terminal voltage waveform chart when a modulation signal applied to each motor coil in the two-phase modulation operation mode, which is a composite waveform of a switching phase, is a sine wave obtained through ⅙ superimposition of a third harmonic on a fundamental wave, and a modulation degree is 180%.

FIG. 26 is an interphase voltage waveform chart in the two-phase modulation operation mode in FIG. 25.

FIG. 27 is a graph illustrating a torque curve at a modulation degree of 130%.

FIG. 28 is a graph illustrating a torque curve at a modulation degree of 180%.

FIG. 29 is a table illustrating relationship of an interphase output ratio when a modulation degree is changed.

FIG. 30 is a block configuration diagram illustrating one example of a motor driving circuit.

FIG. 31 is a graph illustrating a concept of an interphase output in the present disclosure and showing that the interphase output is an integral value of absolute values of an interphase voltage waveform for one period.

### DESCRIPTION OF EMBODIMENTS

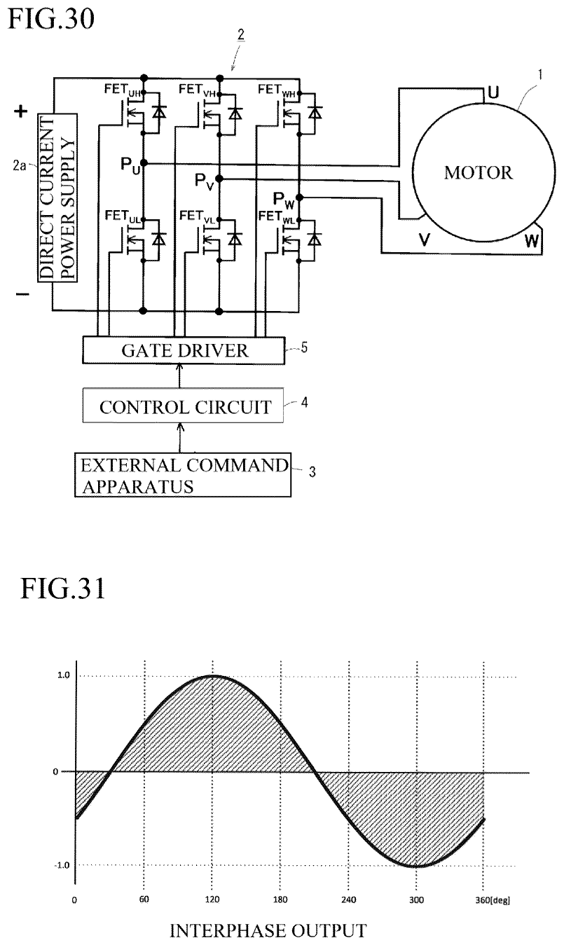

Hereinafter, embodiments of a motor driving method according to the present disclosure are described with reference to the accompanying drawings. One example of a motor driving apparatus is described with reference to FIG. 30. In order to avoid complication, description of a clock generation unit, a communication unit, a motor current detection circuit, and the like is omitted. Moreover, in the description, a three-phase brushless motor is illustrated as one example of a three-phase motor.

In FIG. 30, for example, a three-phase brushless motor 1 is provided with a permanent magnet field system at a rotor, and includes, at a stator, a stator core having pole teeth disposed to face the permanent magnet with phase difference at a mechanical angle of 120 degrees. Motor coils are wound around the respective pole teeth and phase ends of respective ones of a U-phase, a V-phase, and a W-phase are connected to an inverter circuit 2. The inverter circuit 2 is powered from a direct current power supply 2a. Note that the motor coils may adopt delta connection for connecting adjacent phases without a neutral point. The three-phase brushless motor 1 may be of either an inner rotor type or an outer rotor type. Moreover, the permanent-magnet-type field system may be either an interior permanent magnet (IPM) motor or a surface permanent magnet (SPM) motor.

An external command apparatus 3 sends a rotation command (RUN) to a control circuit 4 (MPU). The control circuit 4 includes a logic circuit (LOGIC) and a PWM controller, a current amplifier and an AD converter circuit, and the like (not illustrated) built therein. The logic circuit stores an energization pattern for energization at an electrical angle of 180 degrees. The PWM controller generates a PWM control signal based on the energization pattern.

When the control circuit 4 receives the rotation command from the external command apparatus 3, the control circuit 4 generates the PWM control signal through the logic circuit (LOGIC) and the PWM controller. The PWM controller sends a direct-current gate signal to a gate driver 5. Upon receiving the gate signal, the gate driver 5 sends a gate output applied with voltage amplification to the inverter circuit 2. The gate driver 5 includes a charge pump circuit that increases gate output voltage, a through-current prevention circuit, and the like built therein. The inverter circuit 2 is an inverter circuit with a three-phase half-bridge configuration. When the inverter circuit 2 receives an input of the gate output from the gate driver 5, a switching device (FET) of a high-side arm or a low-side arm of each phase turns ON, and coil voltage applied with power amplification is output to the three-phase coils U, V, W. A FET is used as the switching device, and a body diode is built therein. The control circuit 4 performs positional detection of the permanent magnet field system based on a current value and a voltage value obtained through sensing of the three-phase coils.

Here, a modulation degree in PWM of the present disclosure is described with reference to the drawings.

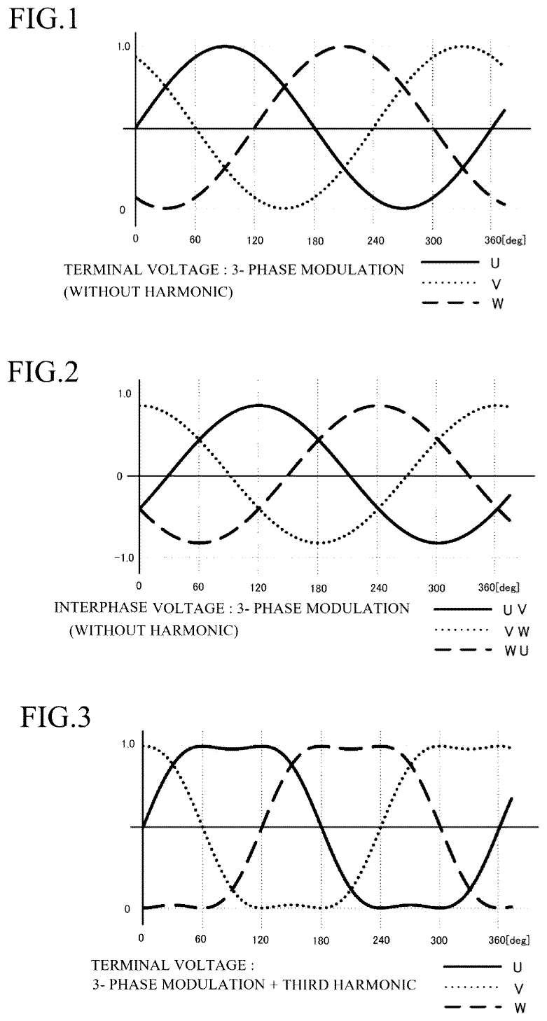

FIG. 1 is a waveform of a PWM driving signal in general sinusoidal drive of three-phase modulation, and illustrates terminal voltage applied to each of the three-phase coils U, V, W. A duty ratio is defined in such a manner that an infinitesimal time average value forms a sine wave with respect to an electrical angle of the rotor. The PWM is performed at this duty ratio and the PWM driving signal is output to the inverter circuit 2. A “modulation signal” in the claims means a curve of a U-phase (solid line), a V-phase (dotted line), or a W-phase (broken line) defining a duty ratio of terminal voltage applied to each one of the three-phase coils. An intersecting point between the rotor electrical angle (horizontal axis) and the modulation signal uniquely determines a duty ratio of voltage applied to each phase U, V, W.

FIG. 2 indicates relation between each of U-V, V-W, and W-U voltage (interphase voltage) and the rotor electrical angle with regard to FIG. 1. This interphase voltage indicates, similarly to the terminal voltage described above, an infinitesimal time average value when PWM is applied.

A maximum value of the waveform of the terminal voltage in FIG. 1 is 1.0 (duty ratio of 100%). On the other hand, although a waveform of each interphase voltage in FIG. 2 is a sine wave, a maximum value of an absolute value thereof does not reach 1.0. Therefore, the PWM driving signal applied with the PWM using only a sine wave has room for an increase in output.

FIG. 3 illustrates terminal voltage applied to each of the three-phase coils U, V, W when a PWM driving signal in three-phase modulation is not a simple sine wave, but a superimposed sine wave including a ⅙ third harmonic with respect to a fundamental frequency signal, and this driving signal is used.

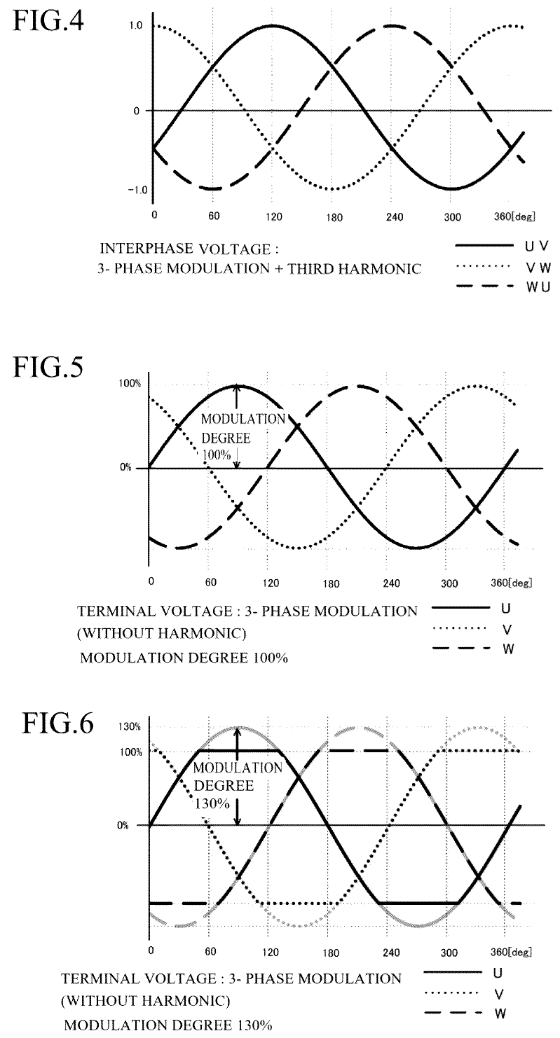

FIG. 4 indicates relation between each of U-V, V-W, and W-U voltage (interphase voltage) and the rotor electrical angle with regard to FIG. 3. This interphase voltage indicates, similarly to the terminal voltage described above, an infinitesimal time average value when PWM is applied.

As shown by the waveforms in FIG. 4, the waveforms of the interphase voltage are sine waves, and a maximum value thereof improves to be 1.0. In this manner, when the PWM driving signal used is not a simple sine wave but the superimposed sine wave obtained through superimposition of the third harmonic on the fundamental wave, the terminal voltage waveform has a trapezoid shape as illustrated in FIG. 3, output density with respect to the rotor electrical angle improves, the interphase voltage illustrated in FIG. 4 also improves, and thus the motor output as a whole can improve.

Such a method is a well-known, generally used technique.

FIGS. 5 and 6 are waveform charts for explaining a concept of the modulation degree.

FIG. 5 shows an example in which a sine wave including only a fundamental wave is used as a PWM driving signal, and illustrates terminal voltage applied to each of the three-phase coils U, V, W. As illustrated in this figure, when a maximum value (=amplitude) of the PWM driving signal is 1.0, a maximum modulation degree is 100%, which means, for example, PWM is performed at the modulation degree of 100% (=duty ratio of 100%) with respect to the U-phase at an electrical angle of 90 degrees.

FIG. 6 is an example in which, similarly to FIG. 5, a sine wave including only a fundamental wave is used as a PWM driving signal, and illustrates terminal voltage applied to each of the three-phase coils U, V, W. As illustrated in this figure, when a maximum value (=amplitude) of the PWM driving signal is 1.3, a maximum modulation degree is 130%. However, since the PWM duty ratio cannot be more than 100%, the duty ratio is 100% in an electrical angle section in which an amplitude of the PWM driving signal exceeds 1.0 (modulation degree exceeds 100%). This means that, for example, PWM is performed in such a manner that the modulation degree with respect to the U-phase at an electrical angle of 90 degrees is 130%, whereas the duty ratio is 100%.

In this manner, “including an electrical angle section in which a modulation degree of a PWM driving signal exceeds 100%, and a duty ratio being 100% in this electrical angle section” is referred to as overmodulation in the disclosure.

Next, one example of a motor driving method using the above-described motor driving apparatus is described. The control circuit 4 can perform a three-phase modulation operation mode in which a three-phase modulation PWM driving signal is output as a PWM driving signal to the inverter circuit 2 in order to perform the three-phase modulation as illustrated in FIG. 1. A duty ratio of terminal voltage for the coil of each phase U, V, W is set and output in accordance with the rotor electrical angle. When the rotor starts rotation, the electrical angle changes, and the duty ratio of terminal voltage for the coil of each phase U, V, W is reconfigured and output in accordance with the changed electrical angle. Continuous performance of such operation enables PWM control to keep rotating the rotor.

Note that magnitude of amplitudes of the curves of the U-phase (solid line), the V-phase (dotted line), and the W-phase (broken line) in FIG. 1 on which the PWM driving signal described above is based can be changed to adjust intensity of the motor output.

Below, a terminal voltage waveform chart and an interphase voltage waveform chart in the three-phase modulation operation mode are described while changing a modulation degree.

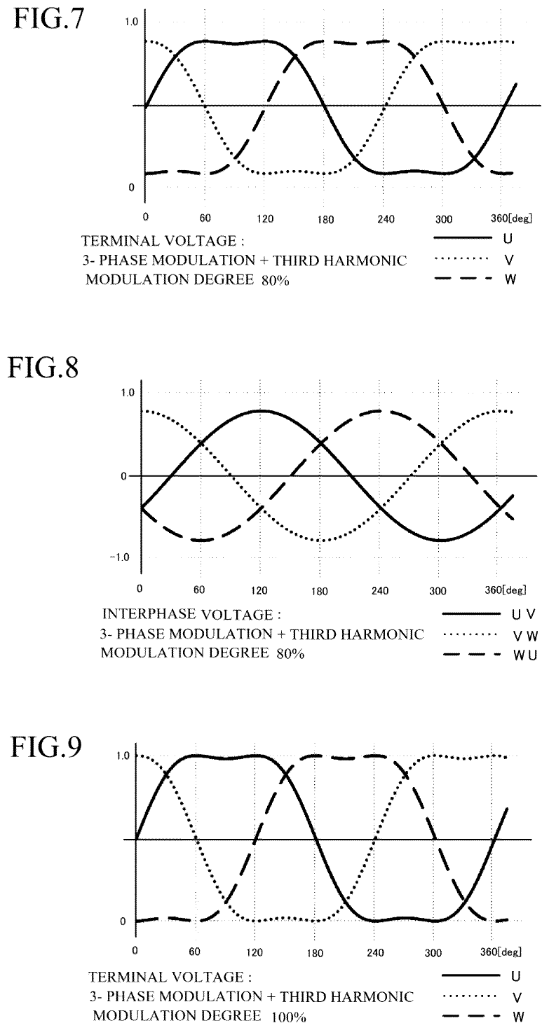

FIG. 7 illustrates a terminal voltage waveform chart when a modulation signal (PWM driving signal) applied to each motor coil in the three-phase modulation operation mode is a sine wave obtained through ⅙ superimposition of a third harmonic on a fundamental wave, and a modulation degree is 80%. A solid line indicates U-phase coil voltage, a dotted line indicates V-phase coil voltage, and a broken line indicates W-phase coil voltage.

FIG. 8 illustrates an interphase voltage waveform chart in the three-phase modulation operation mode in FIG. 7. A solid line indicates UV interphase voltage, a dotted line indicates VW interphase voltage, and a broken line indicates WU interphase voltage.

FIG. 9 illustrates a terminal voltage waveform chart when a modulation signal (PWM driving signal) applied to each motor coil in the three-phase modulation operation mode is a sine wave obtained through ⅙ superimposition of a third harmonic on a fundamental wave, and a modulation degree is 100%. A solid line indicates U-phase coil voltage, a dotted line indicates V-phase coil voltage, and a broken line indicates W-phase coil voltage.

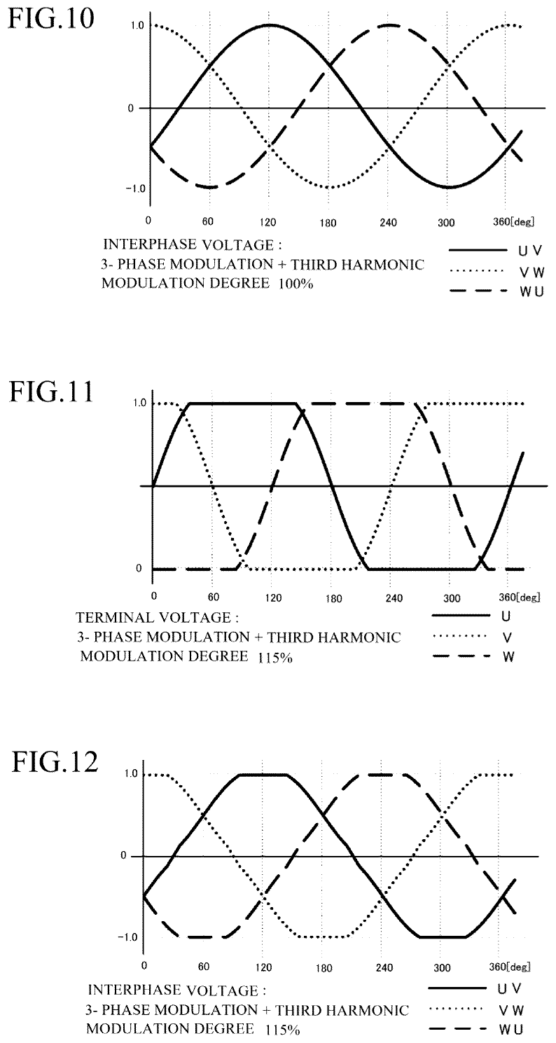

FIG. 10 illustrates an interphase voltage waveform chart (sine-wave waveform chart) in the three-phase modulation operation mode in FIG. 9. A solid line indicates UV interphase voltage, a dotted line indicates VW interphase voltage, and a broken line indicates WU interphase voltage.

FIG. 11 illustrates a terminal voltage waveform chart when a modulation signal (PWM driving signal) applied to each motor coil in the three-phase modulation operation mode is a sine wave obtained through ⅙ superimposition of a third harmonic on a fundamental wave, and a modulation degree is 115%. A solid line indicates U-phase coil voltage, a dotted line indicates V-phase coil voltage, and a broken line indicates W-phase coil voltage. When the modulation degree exceeds 100%, the terminal voltage waveform has an amplitude more than 1.0. However, PWM control does not have a state in which an output exceeds 100%, and thus the terminal voltage waveform includes, at a positive side and a negative side, a section where a maximum output is flat.

FIG. 12 illustrates an interphase voltage waveform chart (sine-wave waveform chart) in the three-phase modulation operation mode in FIG. 11. A solid line indicates UV interphase voltage, a dotted line indicates VW interphase voltage, and a broken line indicates WU interphase voltage. The interphase voltage waveform includes, at a positive side and a negative side, a section where a maximum output is flat.

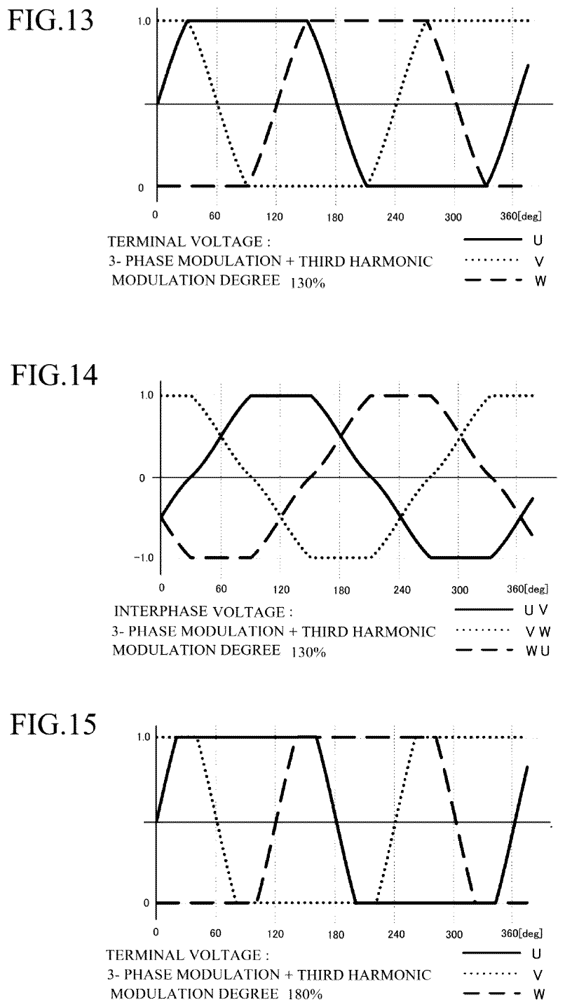

FIG. 13 illustrates a terminal voltage waveform chart (trapezoid-wave waveform chart) when a modulation signal (PWM driving signal) applied to each motor coil in the three-phase modulation operation mode is a sine wave obtained through ⅙ superimposition of a third harmonic on a fundamental wave, and a modulation degree is 130%. A solid line indicates U-phase coil voltage, a dotted line indicates V-phase coil voltage, and a broken line indicates W-phase coil voltage. When the modulation degree exceeds 100%, the terminal voltage waveform has an amplitude more than 1.0. However, PWM control does not have a state in which an output exceeds 100%, and thus the terminal voltage waveform includes, at a positive side and a negative side, a section where a maximum output is flat. Moreover, the flat section is extended as compared to the case in which the modulation degree is 115% (see FIG. 11).

FIG. 14 illustrates an interphase voltage waveform chart (trapezoid-wave waveform chart) in the three-phase modulation operation mode in FIG. 13. A solid line indicates UV interphase voltage, a dotted line indicates VW interphase voltage, and a broken line indicates WU interphase voltage. The interphase voltage waveform includes, at a positive side and a negative side, a flat section where a maximum output is flat. The flat section is extended as compared to the case in which the modulation degree is 115% (see FIG. 12).

FIG. 15 illustrates a terminal voltage waveform chart (trapezoid-wave waveform chart) when a modulation signal (PWM driving signal) applied to each motor coil in the three-phase modulation operation mode is a sine wave obtained through ⅙ superimposition of a third harmonic on a fundamental wave, and a modulation degree is 180%. A solid line indicates U-phase coil voltage, a dotted line indicates V-phase coil voltage, and a broken line indicates W-phase coil voltage. When the modulation degree exceeds 100%, the terminal voltage waveform has an amplitude more than 1.0. However, PWM control does not have a state in which an output exceeds 100%, and thus the terminal voltage waveform includes, at a positive side and a negative side, a section where a maximum output is flat. Moreover, the flat section is slightly extended as compared to the case in which the modulation degree is 130% (see FIG. 13).

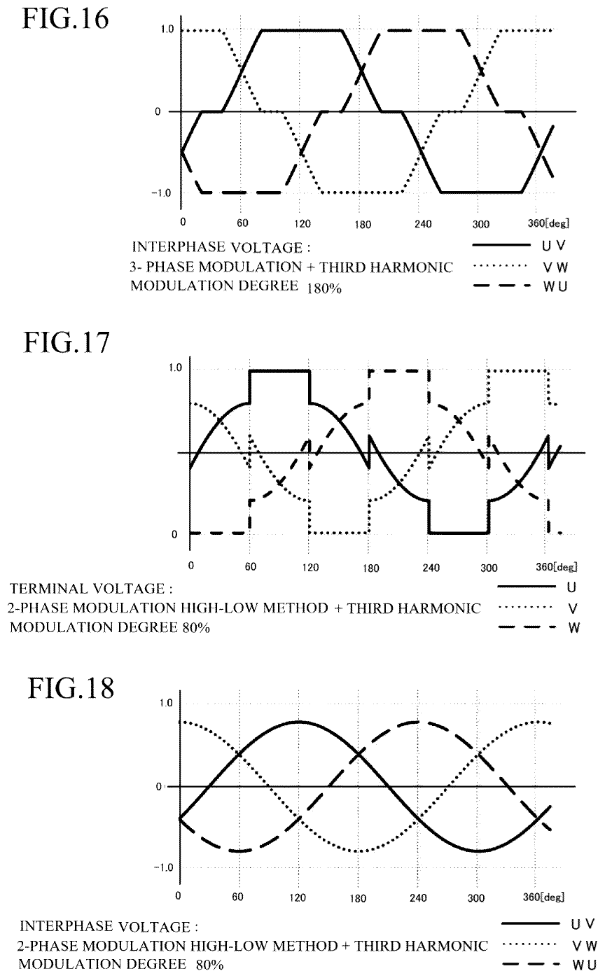

FIG. 16 illustrates an interphase voltage waveform chart in the three-phase modulation operation mode in FIG. 15. A solid line indicates UV interphase voltage, a dotted line indicates VW interphase voltage, and a broken line indicates WU interphase voltage. The interphase voltage waveform includes, at a positive side and a negative side, a flat section where a maximum output is flat. The flat section is extended as compared to the case in which the modulation degree is 130% (see FIG. 14).

Next, a terminal voltage waveform and an interphase voltage waveform in a two-phase modulation operation mode are described while sequentially changing a modulation degree. A two-phase modulation method (high-low method) is a method in which, in PWM control, voltage of one phase is fixed to High or Low and voltage of the other two phases is modulated in a specific section in one period of a signal wave that is compared with a modulation wave. For example, U-phase voltage is fixed to High in an electrical angle section from 60 degrees to 120 degrees, and signals delayed by an electrical angle of 120 degrees and an electrical angle of 240 degrees with respect to the U-phase are output to the V-phase and the W-phase. In a similar manner, V-phase voltage is fixed to Low in an electrical angle section from 120 degrees to 180 degrees, and signals delayed by an electrical angle of 120 degrees and an electrical angle of 240 degrees with respect to the V-phase are output to the U-phase and the W-phase.

FIG. 17 is a terminal voltage (coil average application voltage) waveform chart when a modulation signal (PWM driving signal) applied to each motor coil in the two-phase modulation operation mode, which is a composite waveform of a switching phase, is a sine wave obtained through ⅙ superimposition of a third harmonic on a fundamental wave, and a modulation degree is 80%. A solid line indicates U-phase coil voltage, a dotted line indicates V-phase coil voltage, and a broken line indicates W-phase coil voltage. The terminal voltage waveform includes, at a positive side and a negative side, a section where a maximum output is flat.

FIG. 18 is an interphase voltage waveform chart (sine-wave waveform chart) in the two-phase modulation operation mode in FIG. 17. A solid line indicates UV interphase voltage, a dotted line indicates VW interphase voltage, and a broken line indicates WU interphase voltage.

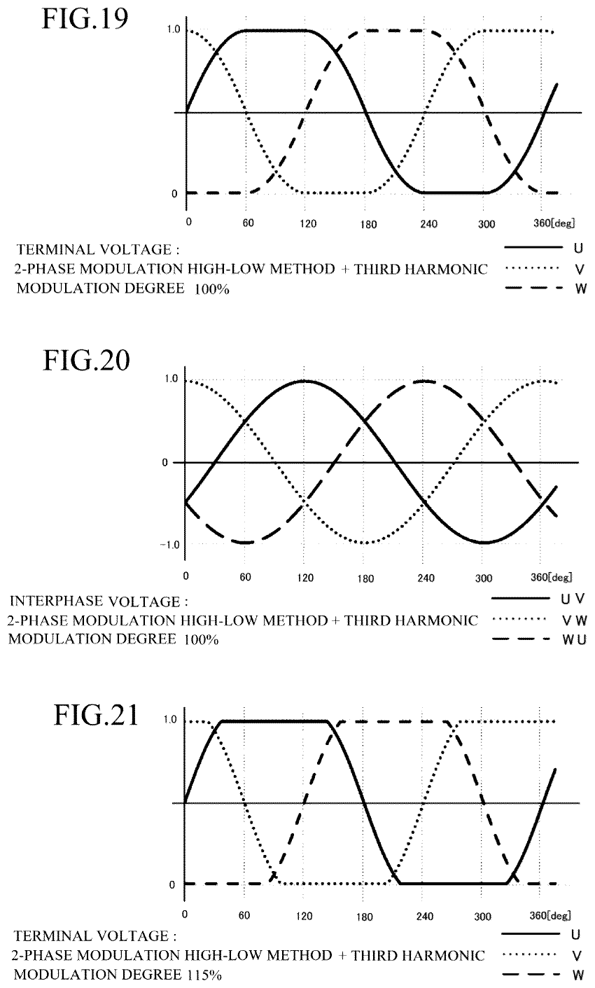

FIG. 19 illustrates a terminal voltage waveform chart when a modulation signal (PWM driving signal) applied to each motor coil in the two-phase modulation operation mode, which is a composite waveform of a switching phase, is a sine wave obtained through ⅙ superimposition of a third harmonic on a fundamental wave, and a modulation degree is 100%. A solid line indicates U-phase coil voltage, a dotted line indicates V-phase coil voltage, and a broken line indicates W-phase coil voltage. The terminal voltage waveform includes, at a positive side and a negative side, a flat section where a maximum output is flat. The flat section is extended as compared to the case in which the modulation degree is 80%.

FIG. 20 is an interphase voltage waveform chart (sine-wave waveform chart) in the two-phase modulation operation mode in FIG. 19. A solid line indicates UV interphase voltage, a dotted line indicates VW interphase voltage, and a broken line indicates WU interphase voltage.

FIG. 21 illustrates a terminal voltage waveform chart when a modulation signal (PWM driving signal) applied to each motor coil in the two-phase modulation operation mode, which is a composite waveform of a switching phase, is a sine wave obtained through ⅙ superimposition of a third harmonic on a fundamental wave, and a modulation degree is 115%. A solid line indicates U-phase coil voltage, a dotted line indicates V-phase coil voltage, and a broken line indicates W-phase coil voltage. The terminal voltage waveform includes, at a positive side and a negative side, a section where a maximum output is flat. The flat section is extended as compared to the case in which the modulation degree is 100%.

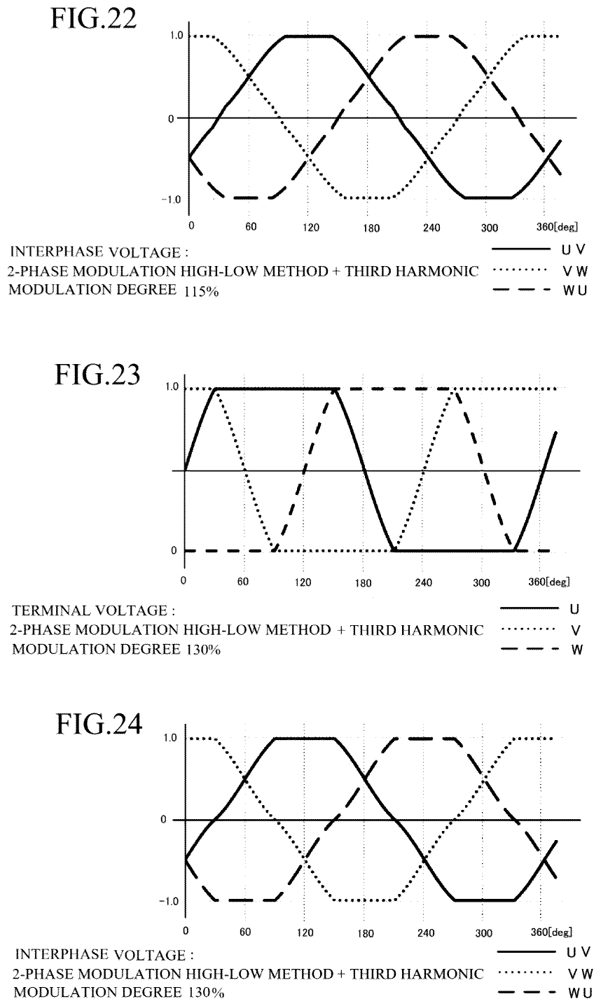

FIG. 22 illustrates an interphase voltage waveform chart (sine-wave waveform chart) in the two-phase modulation operation mode in FIG. 21. A solid line indicates UV interphase voltage, a dotted line indicates VW interphase voltage, and a broken line indicates WU interphase voltage. The interphase voltage waveform includes, at a positive side and a negative side, a section where a maximum output is flat.

FIG. 23 illustrates a terminal voltage waveform chart (trapezoid-wave waveform chart) when a modulation signal (PWM driving signal) applied to each motor coil in the two-phase modulation operation mode, which is a composite waveform of a switching phase, is a sine wave obtained through ⅙ superimposition of a third harmonic on a fundamental wave, and a modulation degree is 130%. A solid line indicates U-phase coil voltage, a dotted line indicates V-phase coil voltage, and a broken line indicates W-phase coil voltage. The terminal voltage waveform includes, at a positive side and a negative side, a section where a maximum output is flat. Moreover, the flat section is extended as compared to the case in which the modulation degree is 115% (see FIG. 21).

FIG. 24 illustrates an interphase voltage waveform chart (trapezoid-wave waveform chart) in the two-phase modulation operation mode in FIG. 23. A solid line indicates UV interphase voltage, a dotted line indicates VW interphase voltage, and a broken line indicates WU interphase voltage. The interphase voltage waveform includes, at a positive side and a negative side, a flat section where a maximum output is flat. The flat section is extended as compared to the case in which the modulation degree is 115% (see FIG. 22).

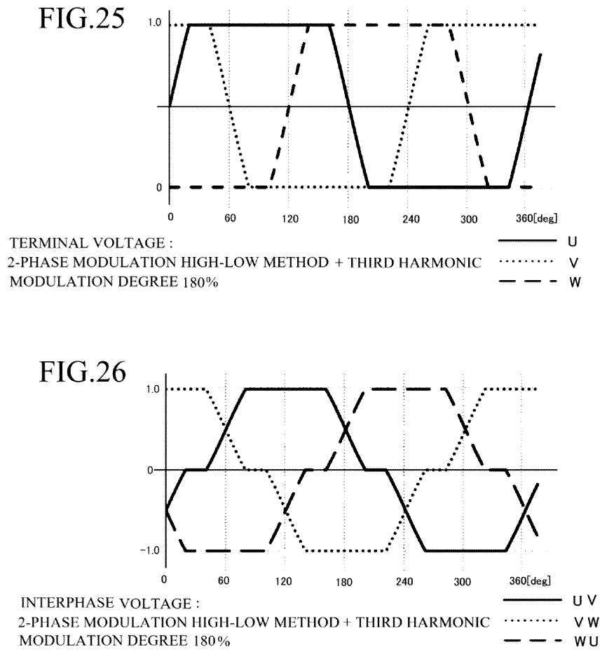

FIG. 25 illustrates a terminal voltage waveform chart (trapezoid-wave waveform chart) when a modulation signal (PWM driving signal) applied to each motor coil in the two-phase modulation operation mode, which is a composite waveform of a switching phase, is a sine wave obtained through ⅙ superimposition of a third harmonic on a fundamental wave, and a modulation degree is 180%. A solid line indicates U-phase coil voltage, a dotted line indicates V-phase coil voltage, and a broken line indicates W-phase coil voltage. The terminal voltage waveform includes, at a positive side and a negative side, a section where a maximum output is flat. The flat section is slightly extended as compared to the case in which the modulation degree is 130% (see FIG. 23).

FIG. 26 illustrates an interphase voltage waveform chart in the two-phase modulation operation mode in FIG. 25. A solid line indicates UV interphase voltage, a dotted line indicates VW interphase voltage, and a broken line indicates WU interphase voltage. The interphase voltage waveform includes, at a positive side and a negative side, a flat section where a maximum output is flat. The flat section is extended as compared to the case in which the modulation degree is 130% (see FIG. 24).

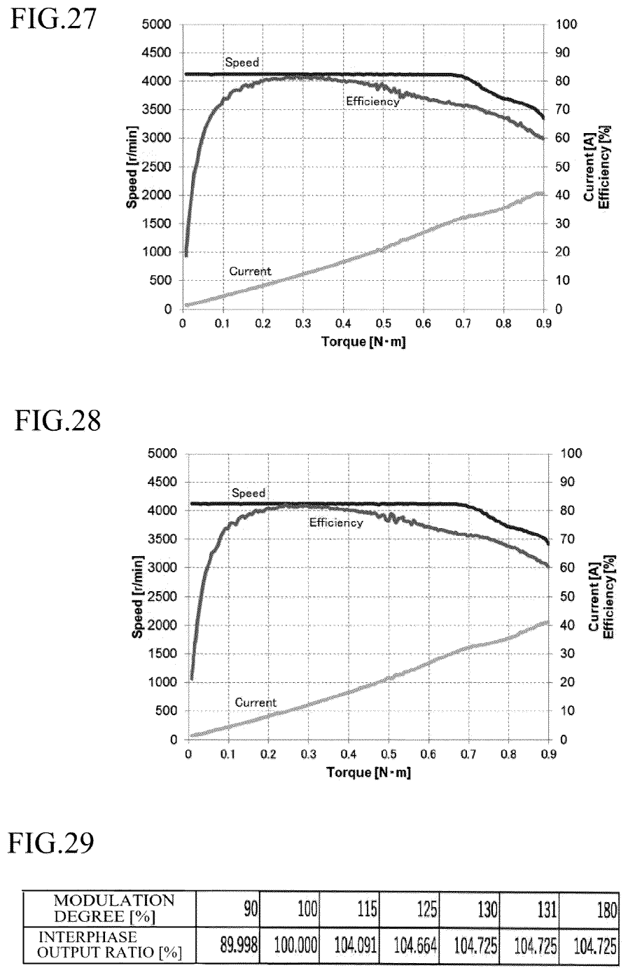

It is apparent from the above experiment results that, in both of the three-phase modulation operation mode and the two-phase modulation operation mode, when compared based on an interphase output (an integral value of absolute values of an interphase voltage waveform for one period, see FIG. 31), the interphase output is approximately constant when a modulation degree exceeds a certain value regardless of change in the modulation degree to a certain extent or more. Specifically, it is apparent that even when the modulation degree exceeds 130%, the interphase output is constant without large difference. FIGS. 27 and 28 are graphs in which torque curves at a modulation degree of 130% and a modulation degree of 180% in the three-phase modulation operation mode are compared. It can be seen that although the torque is slightly higher at the modulation degree of 180% (FIG. 28), difference is minute as compared to the modulation degree at 130%.

FIG. 29 is a table illustrating relationship of an interphase output ratio when a modulation degree is changed in the three-phase modulation operation mode and the two-phase modulation operation mode. The interphase output ratio is a relative value in a case in which an interphase output at a modulation degree of 100% is 100. It can be seen that although the interphase output increases as the modulation degree increases, the interphase output remains the same after the modulation degree reaches a limit of 130%. Moreover, when the modulation degree exceeds 130%, in the case of sensorless drive, a positional detection section (dead time) of the permanent magnet field system is shortened, and controllability decreases.

As described above, by setting a modulation degree of an overmodulation PWM driving signal to be more than 100% and equal to or less than 130%, a motor output can improve while having an upper limit of the modulation degree at 130% at which the motor output level hits a peak. Therefore, positional detection precision of the permanent magnet field system in sensorless drive can be secured.

Note that even when the modulation degree of the overmodulation PWM driving signal is at a degree of 180%, positional detection of the permanent magnet field system by sensorless drive is possible. However, positional detection precision and controllability decrease and an increase in an interphase output cannot be expected. Therefore, by using the range in which a modulation degree is more than 100% and equal to or less than 130% where an improvement in output can be expected while a sensing range (operation stability) in sensorless drive is secured, a motor can achieve both of driving stability and output improvement.

As a method for the sensorless drive in the disclosure, a single-shunt FOC sensorless detection method in which at least one phase in sensing for magnetic pole positional estimation is in a switching state, and a method in which sensing for magnetic pole positional estimation is performed during dead time can be utilized individually or concurrently.

Moreover, in the description of the disclosure, it is assumed that a “sine wave obtained through superimposition of a third harmonic on a fundamental wave” is used as a PWM driving signal. However, a genuine sine wave as illustrated in FIG. 1 can be used, and in such a case, a modulation degree applicable as overmodulation is 200% at the maximum.

Here, one example of a specific motor driving method of a three-phase direct-current brushless motor is described. The control circuit 4 includes a three-phase overmodulation operation mode, a two-phase overmodulation operation mode, and a transitional operation mode. In the three-phase overmodulation operation mode, the control circuit 4 outputs, as a PWM driving signal, a three-phase overmodulation PWM driving signal to the inverter circuit 2. In the two-phase overmodulation operation mode, the control circuit 4 outputs, as a PWM driving signal, a two-phase overmodulation PWM driving signal to the inverter circuit 2. In the transitional operation mode, the control circuit 4 outputs to the inverter circuit 2 a transition overmodulation signal in which a mixture ratio of a three-phase overmodulation PWM driving signal and a two-phase overmodulation PWM driving signal is gradually changed.

The three-phase overmodulation operation mode and the two-phase overmodulation operation mode are performed in an overmodulation state where a modulation degree of a PWM driving signal is 130% at the maximum as described above. However, the modulation degree may be changed as appropriate in accordance with situations, such as a startup from a stopped state, deceleration from a high-speed rotation state, and load fluctuation in a constant-speed state, so as to adjust an output. Moreover, although the three-phase modulation operation mode causes less vibration and less noise as compared to the two-phase modulation operation mode, it is inferior in terms of efficiency. Therefore, one of the three-phase modulation operation mode and the two-phase modulation operation mode is selected in accordance with load characteristics and an application demand.

In the transitional operation mode, waveforms of a three-phase modulation signal and a two-phase modulation signal at a modulation degree within a range from 0% to 100% are mixed, and the mixture ratio is gradually changed. At this time, the ratio is changed in such a manner that the ratio of the three-phase modulation signal decreases and the ratio of the two-phase modulation signal increases per electrical angle section of 60 degrees. The motor may be started-up in the three-phase modulation operation mode at a modulation degree from 0% to 100%, the three-phase modulation operation mode may be switched to the two-phase modulation operation mode at a modulation degree from 0% to 100% via the transitional operation mode, and then motor drive may be performed in the two-phase modulation operation mode at a modulation degree from 100% to 130%.

Accordingly, during low-speed drive, a three-phase direct-current brushless motor is driven by a three-phase modulation PWM driving signal that causes small vibration and small noise, and in the case of high-speed rotation, high load, or high temperature, the three-phase direct-current brushless motor is driven by a two-phase modulation PWM driving signal that is advantageous in terms of heat generation of a switching device and excels in energy utilization efficiency. Therefore, a high output during low-speed drive reduces vibration and noise, and a high output during high-speed rotation, high load, or high temperature can reduce the number of switching to decrease a heat generation amount of the switching device, thus contributing to energy conservation.

The motor driving method described above is suitably used for a voltage-type inverter control system, such as an inverter air conditioner, an inverter home appliance, and a compressor.

What is claimed is:

1. A motor driving method for driving a three-phase brushless motor in a pulse width modulation method, wherein the three-phase brushless motor comprises:
an inverter circuit comprising an output element provided with a pair of a high-side arm and a low-side arm for each of three phases of the three-phase brushless motor, and configured to output current to a coil of each of the three phases; and
a control circuit configured to control an output of a pulse signal to the inverter circuit by performing pulse width modulation to determine a duty ratio based on an input modulation signal and outputting a pulse signal, and
the control circuit is configured to:
upon reception of an input of a given minimum value as the modulation signal, output a pulse signal at a duty ratio of 0% to the inverter circuit;
upon reception of an input of a given maximum value as the modulation signal, output a pulse signal at a duty ratio of 100% to the inverter circuit; and
in an overmodulation state, output a pulse signal at a duty ratio of 100% to the inverter circuit, wherein the overmodulation state is a state in which an overmodulation signal having a maximum modulation degree of more than 100% is input as the modulation signal and an instantaneous value of the modulation signal is more than the given maximum value, the maximum modulation degree being a ratio of a maximum value of the modulation signal to the given maximum value.

2. The motor driving method according to claim 1, wherein the modulation signal is a signal obtained through superimposition of, on a sine wave at a given frequency, a sine wave at a frequency three times the given frequency, and a modulation degree in the overmodulation state using the superimposed signal as the modulation signal is 130% at the maximum.

3. The motor driving method according to claim 1, wherein the three-phase brushless motor is a sensorless motor.

4. The motor driving method according to claim 3, wherein a method for positional detection of a rotor of the sensorless motor is one or both of a single-shunt FOC sensorless detection method in which at least one phase in sensing for magnetic pole positional estimation is in a switching state, and a detection method in which sensing for magnetic pole positional estimation is performed during dead time.

5. The motor driving method according to claim 1, wherein the control circuit includes:
a three-phase modulation operation mode to drive the motor by outputting a pulse width modulation signal to the coil of each of the three phases of the three-phase brushless motor;
a two-phase modulation operation mode to drive the motor by outputting a pulse width modulation signal to the coil of each of two phases among the three phases of the three-phase brushless motor; and
a transitional operation mode to drive the motor by outputting a transition modulation signal in which a mixture ratio of a pulse width modulation signal for each phase in the three-phase modulation operation mode and a pulse width modulation signal for each phase in the two-phase modulation operation mode is gradually changed, and
the three-phase operation mode is operated from a startup until an output reaches a maximum output in the overmodulation state, the two-phase operation mode is operated from a startup until an output reaches a maximum output in the overmodulation state, or the three-phase operation mode is operated at a startup, and then as an output increases, the three-phase operation mode is switched to the two-phase operation mode until the output reaches a maximum output in the overmodulation state via the transitional operation mode.
